(19) United States
(12) Patent Application Publication
(10) Pub. No.: US 2005/0047880 A1
(43) Pub. Date: Mar. 3, 2005

(54) Metal shaving collector

(76) Inventor: Scott C. Seely, Grand Rapids, MI (US)

Correspondence Address: Waters & Morse, P.C., 400 Ledyard Building, 125 Ottawa, N.W., Grand Rapids, MI, 49503, US

(21) Appl. No.: 10/648,756

(22) Filed: Aug. 26, 2003

(51) Int. Cl. B23B 47/00

(52) U.S. Cl. 408/67

(57) ABSTRACT

A shaving collector for collecting ferrous metal shavings produced by the operation of a drill bit in drilling a hole in a ferrous metal panel comprises a hollow cup-shaped body having an open end, with the open end including a ring magnet around the periphery thereof. The open end can be magnetically attached over a hole drilling location in the rear side a ferrous metal panel, opposite a front side of the panel where a drill is to be applied to the panel. Shavings that fall through the hole produced by the drilling operation are collected in the open interior of the collector, the collector being removable from the ferrous metal material after the drilling operation in order to discard the shavings at a remote location. The shaving collector preferably is formed of a moldable plastic and can either have a permanently closed outer end or the end can be covered by a removable cap. Both ends can be covered by removable caps, so that the collector can be used as a container for a drill bit or other tool.

### BACKGROUND OF THE INVENTION

The present invention relates to a metal shaving collector and method of use thereof, wherein a magnetized cup collects shavings produced when a hole is drilled in a ferrous metal panel.

When drilling holes in metal cabinet walls and panels that enclose components that are contaminated by metal shavings, such as electrical control panels, computer cabinets and the like, shavings produced in the drilling operation present a real problem. When a hole is being drilled in an upward direction through a panel, shavings fall away from the panel and can be permitted to fall freely or can be collected in a cup held in position by the drill. However, when a hole is to be drilled in a vertical panel or drilled downwardly through a horizontal panel, shavings produced by the drill tend to fall through the hole when it is formed, and this location may be relatively inaccessible by the person operating the drill.

An object of the present invention is to provide a metal shaving collector that will remain in position on the opposite side of a panel where a hole is to be drilled and will collect all of the shavings that fall through the hole, without risk of contaminating components on the opposite side of the panel.

### SUMMARY OF THE INVENTION

In accordance with the present invention, a shaving collector for preventing shavings produced by a drill bit boring a hole through a ferrous metal panel comprises a cup having an open end that is magnetically attachable to the panel at a drill location on the opposite side of the panel from the drill, the cup catching and retaining shavings that pass through a hole in the panel produced by the drill, the shavings being retained in the interior of the cup until the cup is removed from the panel and carried to a remote location where the cup is emptied.

In the preferred practice of the present invention, the collector comprises an elongated plastic tube having at least one open end and having a ring-shaped magnet embedded in a groove around the periphery of the open end, so that the magnet will cause the open end to cling to a ferrous metal panel to which it is attached. An opposite end of the tube is either covered by a removable cap or is integrally formed with a closed end.

These and other features and advantages of the present invention will hereinafter appear in connection with a preferred embodiment of the present invention described below and shown in the appended drawings.

### BRIEF DESCRIPTION OF THE DRAWINGS

FIG. 1 is a perspective view showing the metal shaving collector of the present invention in use.

FIG. 2 is a perspective exploded view showing the open end of the collector and the magnetic ring that is mounted thereon.

FIG. 3 is a side elevational view of a collector having a closed end.

FIG. 4 is an end view of the collector of FIG. 3.

FIG. 5 is a side elevational view of a tubular collector having open ends at both ends, with removable caps closing both ends and showing the collector being used as a container for a drill bit.

FIG. 6 is a fragmentary view of the collector of FIG. 5 showing an alternative cover for the second end of the tube.

### DETAILED DESCRIPTION OF THE INVENTION

Referring to the drawings, a metal shaving collector 10 constructed in accordance with the present invention is shown mounted in position on a ferrous metal panel or wall 12 on a rear side 14 of the panel that is opposite from a front side 16 where a hole is being drilled by a drill 18. As used herein, the term “drill” is intended to include any type of metal working equipment that can produce a hole in a metal panel and will generate metal shavings during the operation. Similarly, the term “panel” is intended to include any sheet or plate material formed of a ferrous or magnet-attracting material, wherein a hole may be formed through the material in such a manner that shavings are produced that fall through the opening produced in the material.

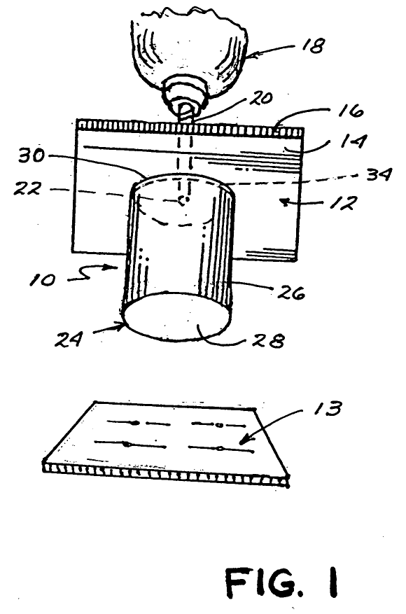

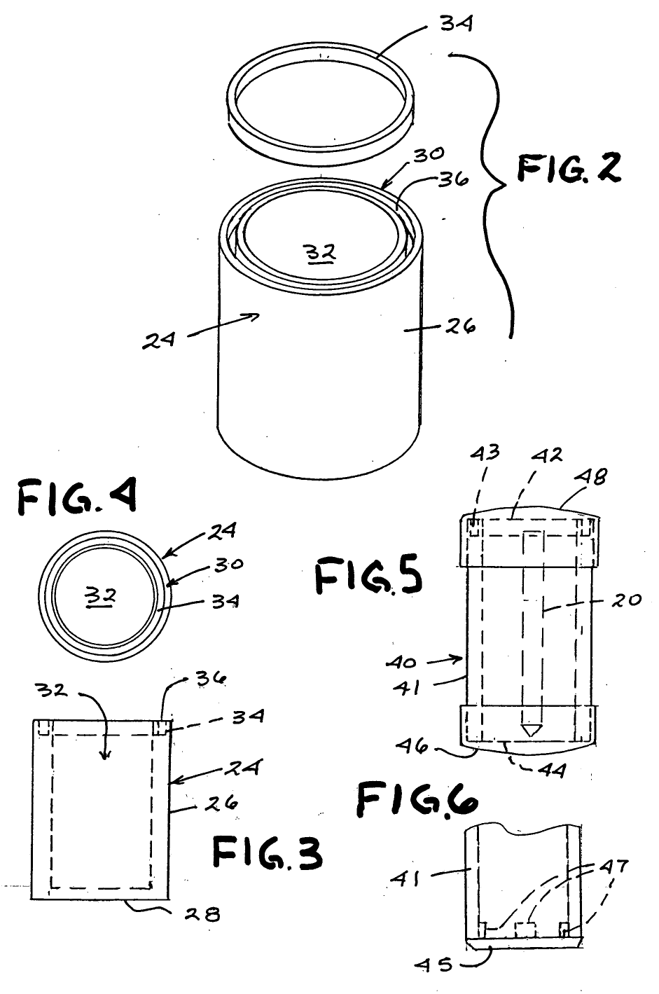

Drill bit 20 of drill 18 is shown in FIG. 1 forming a hole in panel 12 in a direction from front side 16 to rear side 14. The present invention is particularly desirable when the panel is horizontal, with the drill drilling downwardly in the panel, or the panel is vertical.

In order to prevent shavings from falling into live electrical or electronic components 13 and otherwise contaminating components adjacent the panel, metal shaving collector 10 of the present invention is magnetically attached to rear side 14 of the panel opposite from the location where a hole 22 is being drilled in front side 16.

Metal shaving collector 10 comprises a hollow body 24 having sidewalls 26, a closed end 28, and an open end 30. The body has an open interior 32. The body can be shaped in a variety of shapes, as long as the body is generally cup shaped and has an open side that fits flush against a rear side of the panel being drilled, so that shavings falling through hole 22 in the panel fall into the interior of the collector body.

Collector body 24 preferably is formed of a non-conductive plastic resin material. A non-conductive plastic is preferable to a metal when working around electrical systems. A permanent magnetic material 34, which is conventionally available, is attached around the periphery of open end 30 of shaving collector 10. The magnetic material could be discreet magnets positioned at separate locations around the outer periphery of the open end of the collector body 24 or the magnetic material can be a continuous magnetic ring 34, as shown. When a magnetic ring is employed, it desirably fits in groove 36 adjacent end 30, such that the groove holds the ring in place.

In another aspect of the present invention, shown in FIGS. 5 and 6, metal shaving collector 40 comprises an elongated tube 41 having open ends 42 and 44 at both ends. Open end 42 is fitted with a circular magnetic ring 43 as in the previous embodiment. However, the opposite end 44 is closed by a resilient plastic cap 46, such as a vinyl cap that resiliently clings to and closes the open end of the tube. A separate vinyl cap 48 can be used to cover the open end 42 of the tube after shavings have been collected in the tube or before use. When both ends are closed, the invention can also serve as a container to hold things like the drill bit 20 when not in use. An alternative closed end cap 45 is shown in FIG. 6. Cap 45 includes internal prongs or ridges 47 that engage the inside of the tube to hold the cap on the tube.

Desirably, the collector body is about three inches long and about 1.5 inches in diameter. This makes it large enough to hold a drill bit. The magnetic ring desirably is about one-quarter inch long and about one-eighth of an inch thick. These dimensions are not critical and can be varied.

In operation, when it is desired to drill a hole in a panel, such as a horizontal panel 12 shown in FIG. 1 , the collector is first attached magnetically to the underside 14 of the panel at the location where the hole is to be drilled. The hole is then drilled, with the shavings dropping into the cup. The cup can then just be simply removed and the shavings will be retained in the interior of the cup. The cup can then be cleaned by dumping the shavings from the cup at a remote location.

It should be understood that various changes and modifications may be made in the arrangements and details of construction of the embodiments disclosed herein without departing from the spirit and scope of the present invention.

1. A shaving collector for collecting ferrous metal shavings produced by the operation of a drill bit in drilling a hole from a front side to a rear side of a ferrous metal panel, the collector comprising a hollow body having peripheral sides, a closed end, and an open end, the open end including magnet means around the periphery thereof, such that the open end can be magnetically attached over a hole drilling location in the rear side a ferrous metal panel opposite a front side of the panel where a drill is to be applied to the panel, shavings that fall through a hole produced by the drilling operation being collected in an open interior of the collector body, the collector being removable from the ferrous metal material after the drilling operation in order to discard the shavings at a remote location, thereby preventing metal filings from falling through the drilled opening into an area that would be contaminated by such shavings.

2. A shaving collector as in claim 1 wherein the body comprises a tube, with an open end at one end of the tube serving as the open side of the body, an opposite end of the tube being formed or covered so that the opposite end is effectively closed.

3. A shaving collector as in claim 2 wherein the opposite end of the tube is open but is covered by a cap that fits snugly on said opposite end.

4. A shaving collector as in claim 1 wherein the body comprises an elongated tube with an outer end being at least selectively covered, an inner end being open, at least one permanent ring magnet being attached in a groove extending around the periphery of the open end, such that the magnet causes the open end to be releasably attached to a magnet attracting panel.

5. A shaving collector for preventing shavings produced by a drill bit boring through a ferrous metal material from falling through a drilled hole into an area that might be contaminated by the metal shavings, comprising an enclosed hollow cup having an open interior and an open side that fits over the hole boring location on an opposite side from the drill, the open end of the cup being magnetized so that it is releasably held in place on the metal material by magnetic force, shavings falling through the hole being collected in the interior of the cup, the cup shavings being removable with the cup without spilling loose shavings into the space adjacent the hole.

6. A method for collecting metal shavings produced by drilling a hole downwardly or horizontally through a ferrous metal cabinet wall or panel so as to prevent the metal shavings from contaminating components on the opposite side of the wall or panel from the drill, the method comprising affixing a magnetized metal cup over the position where the hole is being drilled on the opposite side of the wall or panel from the drill, such that the magnetized cup clings to the wall or panel and collects and holds ferrous metal shavings produced by the drill, the cup being removable from the panel to discard the shavings at a remote location.
